(19) United States
(12) Patent Application Publication
(10) Pub. No.: US 2016/0140197 A1
(43) Pub. Date: May 19, 2016

(54) CROSS-SYSTEM SYNCHRONIZATION OF HIERARCHICAL APPLICATIONS

(71) Applicants: Tim Gast, Verdun (CA); Ives Toe, Brossard (CA); Sebastien Phan, Boucherville (CA); Evelyna Holban, Laval (CA); Mladen Droshev, Montreal (CA); Unmesh Gandhi, Montreal (CA); GuoTai Chen, Montreal (CA); Pascal Riera, Montreal (CA); Dirk Koelling, Hamburg (DE)

(72) Inventors: Tim Gast, Verdun (CA); Ives Toe, Brossard (CA); Sebastien Phan, Boucherville (CA); Evelyna Holban, Laval (CA); Mladen Droshev, Montreal (CA); Unmesh Gandhi, Montreal (CA); GuoTai Chen, Montreal (CA); Pascal Riera, Montreal (CA); Dirk Koelling, Hamburg (DE)

(21) Appl. No.: 14/541,629

(22) Filed: Nov. 14, 2014

(51) Int. Cl. G06F 17/30; H04L 29/08

(52) U.S. Cl. CPC G06F 17/30575; G06F 17/30424; H04L 67/1095

(57) ABSTRACT

A method, device, and system that relate to synchronization of objects from a Source System and objects in a Target System by a Synchronization Engine situated on the Target System according to a user generated request. A Network handles the user generated request, which includes a selection of a Source System and search criteria, to synchronize the Source System and the Target System. The Synchronization Engine executes synchronization by comparing the hierarchical backend object models of relevant objects in the Source System and in the Target System. The Synchronization Engine provides the user with Search Results detailing the distinctions among the relevant objects. The synchronization process automatically includes objects dependent upon user-selected objects to avoid errors in applications running the synchronized configurations. Consistency checks performed as part of the synchronization ensure that synchronization is properly performed so that the Target System configuration is always in a sound state.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### FIELD

A method, device, and system that relate to synchronization of a Source System and a Target System by a Synchronization Engine situated on the Target System according to a user generated request; and in addition, the invention relates to a Network handling the user generated request from the Synchronization Engine for synchronization of the Source System and the Target System.

### BACKGROUND

In software development environments, developers design, install, configure, and test software applications on a test system. Once the software is tested successfully on the test system and the software application configuration is finalized, the software application needs to be loaded and deployed onto at least one production system. Not all production systems have environments identical to the environments in which the software was tested, and due to differences in these environments, transfers to production systems can be tedious and error-prone.

As an example, two scenarios are presented in which a synchronization device would provide a benefit. First, a user has setup and configured a test system having a plurality of data delivery agreements. The data delivery agreements are main objects, each main object having at least one dependent object. When a need arises to transfer the test system to the production system, the user must perform a manual data transfer, and in doing so, the user is unaware of any inconsistencies resulting from the transfer of data to the production system. In a second case, the user has already transferred an initial version of a test system to a production system. However, since the time of the initial transfer, the test system has been revised. In such a situation, the user may, during a subsequent transfer, omit transferring a particular object from the revisions, or instead, be forced to wipe the production system and begin a new manual transfer to the production system based on the revised test system.

Accordingly, there is a need for development of a device, a system, and a method to synchronize the production system to mimic a relevant object hierarchy of a test system to avoid software malfunction, error, or failure. There is also a need for such a synchronization to be performed in a fast, efficient, and reliable manner across various sorts of development platforms.

### BRIEF DESCRIPTION OF THE DRAWINGS

FIG. 1A is a block diagram of a data model having a first hierarchical presentation of objects 100A and a second hierarchical presentation of objects 100B, according to an example embodiment.

FIG. 1B is a table presentation of the data model and the first and second hierarchical presentation of objects, 100A and 100B.

FIG. 2 illustrates a system 200 in which a Synchronization Engine operates to synchronize at least one Source System with a Target System over a Network according to an example embodiment.

FIG. 3 illustrates a Target System 300 having a Synchronization Engine for synchronizing at least one Source System with a Target System according to an example embodiment.

FIG. 4 is a flowchart of a method 400 for synchronizing a Target System and at least one Source System using a Synchronization Engine according to an example embodiment.

FIG. 5 is a flowchart of a method 500 for performing consistency checks during a synchronization of a Target System and at least one Source System using a Synchronization Engine according to an example embodiment.

FIG. 6 illustrates a user interface 600 available to a user on a Target System hosting a Synchronization Engine for synchronizing the Target System and at least one Source System according to an example embodiment.

### DETAILED DESCRIPTION

Example embodiments of the present invention provide for a method, device, system, and computer program product for synchronizing objects stored on at least one remote system and a Target System. At least one remote system is selected as a Source System. A Target System is the system with which a user interacts. Based on a set of search criteria, specific object related data is provided to the user for both the Source System and the Target System. The specific object related data from the Source System is compared to the specific object related data from the Target System. In the event that the comparison reveals differences between the specific object related data from the Source System and the specific object related data from the Target System, the objects associated with the differences are indicated to the user. The Source System and the Target System are then synchronized by a Synchronization Engine over a Network connection, the synchronization including at least one object selected by the user from the objects associated with the differences.

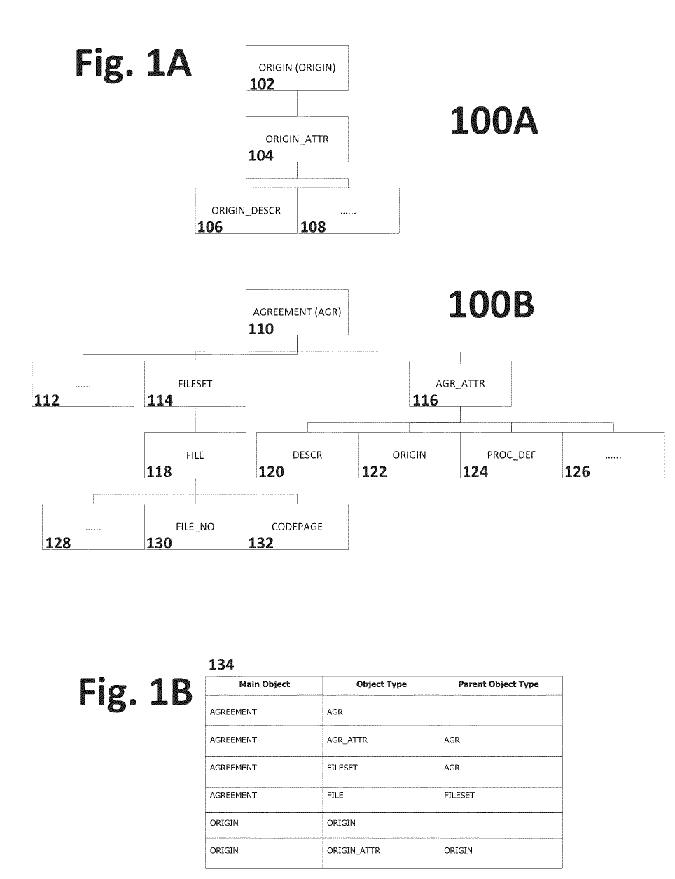

FIG. 1A is a block diagram of a data model having a first hierarchical presentation of objects 100A and a second hierarchical presentation of objects 100B, according to an example embodiment.

In an example embodiment, the first hierarchical presentation of objects 100A exists in both of a Source System and a Target System. First hierarchical presentation of objects 100A has a main object 102, ORIGIN. According to an example embodiment, main object 102 has an object type, ORIGIN. Main object ORIGIN 102 has a dependent object, ORIGIN_ATTR 104. ORIGIN_ATTR 104 is an attribute of its main object, ORIGIN 102. The attribute, ORIGIN_ATTR 104, includes further dependent objects such as ORIGIN_DESCR 106, and other dependent objects, 108, that provide further data about ORIGIN 102. In an example embodiment, ORIGIN_DESCR 106 describes in readable text an attribute of ORIGIN.

In an example embodiment, the second hierarchical presentation of objects object 100B exists in both of a Source System and a Target System. Second hierarchical presentation of objects 100B has a main object 110, AGREEMENT. According to an example embodiment, main object 110 has an object type, AGR. Main object AGREEMENT has at least two dependent objects, FILESET 114 and AGR_ATTR 116. In an example embodiment, main object AGREEMENT has additional dependent objects including object 112. The attribute, AGR_ATTR, includes further dependent objects such as DESCR 120, ORIGIN 122, PROC_DEF 124, and in an example embodiment includes additional dependent objects including object 126. The attribute, FILSET 114, includes a further dependent object, FILE 118, which in turn has at least its respective dependent objects FILE_NO 130 and CODEPAGE 132. In an example embodiment, FILE 118 has additional dependent objects including object 128.

In an example embodiment, the data model, including either or both of the first hierarchical presentation of objects 100A and the second hierarchical presentation of objects 1006, has three types of nodes that can be defined for display. The first node type includes attribute nodes. Attribute nodes show the attributes of an object or a main object. In an example embodiment, each attribute, or descriptive information, of the main object is rendered on one line. The second node type includes key nodes. Key nodes show the key information, or actual data values, that uniquely identify an object or a main object. The third node type includes folder nodes. Folder nodes are used to group nodes together. Folder nodes contain information that is used to group nodes together and to determine parent/child or relative dependency relationships among nodes.

With reference to the example embodiments presented in first data model 100A and second data model 1006, the three types of nodes are displayed. In an example embodiment, ORIGIN_ATTR 104 is an attribute node of main object ORIGIN 102 and AGR_ATTR 116 is an attribute node of main object AGREEMENT 110. In an example embodiment, FILESET 114 is a folder node of main object AGREEMENT 110. In an example embodiment, FILE_NO 130 is a key node, as it provides a definition of a file in terms of a numerical value that it stores. In an example embodiment, a folder node contains another folder node and/or a key node. In an example embodiment, an attribute node contains another attribute node and/or a key node.

In an example embodiment, attribute nodes are categorized as being one of a soft dependency attribute or a hard dependency attribute. In an example embodiment, the attributes of the main object AGREEMENT (AGR) 110, which include objects such as a description (DESCR) 120, an origin (ORIGIN) 122, and a process definition (PROC_DEF) 124, are each either a soft dependency attribute or a hard dependency attribute. The actual attribute node, AGR_ATTR 116, can be synchronized without performing additional checks. Nodes depending from the attribute node AGR_ATTR 116, including attributes such as DESCR 120 and ORIGIN 122 are soft dependency attributes, meaning that they can be synchronized with the synchronization system. In the event that ORIGIN 122 does not exist on the Target System, the Target System will add ORIGIN 122 to a set of objects that are to be synchronized, as ORIGIN 102 belongs to the same data model. Attributes such as PROC_DEF 124 represent a customizable functionality. As PROC_DEF 124 is a customizing relevant object, it is therefore a hard attribute. Accordingly PROC_DEF 124 cannot be synchronized if it does not yet exist on the target system. The hard dependency attribute must exist, however, in the Target System, for the dependent object to be synchronized. In an example embodiment, the additional check performed when the Source System has a hard attribute field under a selected main object is to determine whether the hard attribute also exists in the Target System.

FIG. 1B is a table presentation of the data model and the first and second hierarchical presentation of objects, 100A and 100B. First hierarchical presentation of objects 100A includes hierarchical relationships for the main object Origin. Second hierarchical presentation of objects 100B includes hierarchical relationships for the main object AGREEMENT. The data, as presented in FIG. 1B is a variation of the visual representation presented in FIG. 1A, but the table contains the same data as FIG. 1A. Either one of FIG. 1A or FIG. 1B is a representation of a backend data model that would be used by a Source System or a Target System to determine relative hierarchical object organization prior to performance of a synchronization process.

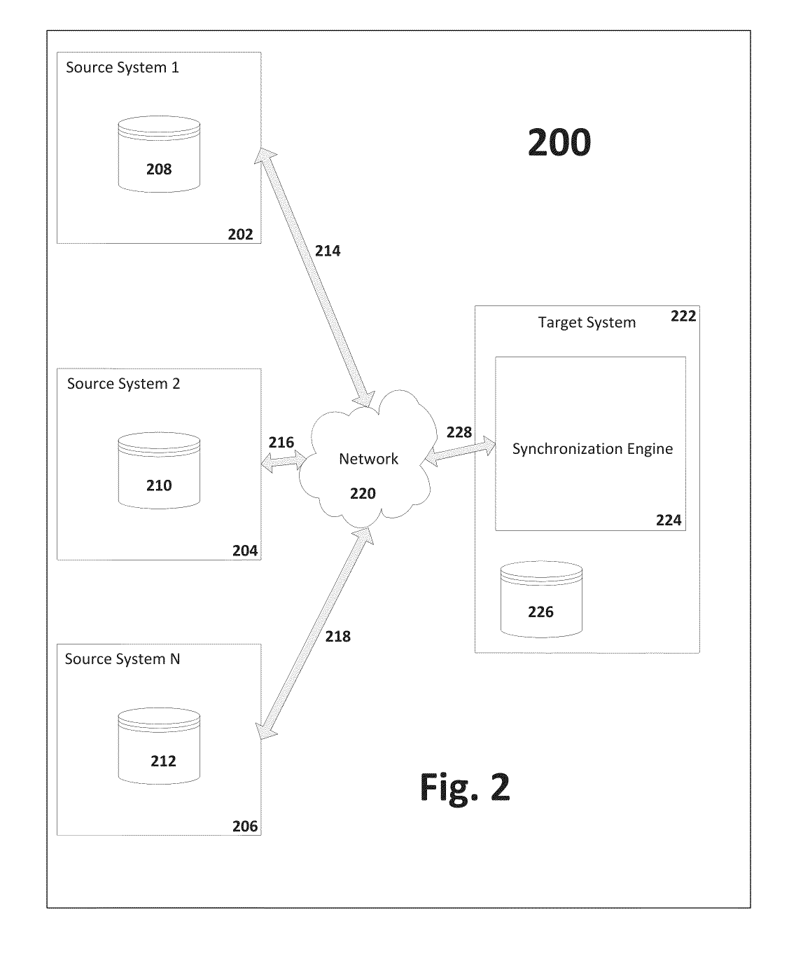

FIG. 2 illustrates a system 200 in which a Synchronization Engine operates to synchronize at least one Source System with a Target System over a Network according to an example embodiment. The system 200 shown in FIG. 2 provides a system overview of the connections between a Target System 222 and the Source Systems, 202, 204, and up to Source System 206. The Target System 222 hosts a Synchronization Engine 224 for synchronizing the Target System 222 and at least one of the Source Systems, including 202, 204, and 206. The Target System has an application configuration 226 that is readable/writable so that it can be synchronized with the selected Source System. Each of the available Source Systems, 202, 204, and 206, has a unique application configuration including 208, 210, and 212, respectively. The Target System 222 is connected via a bidirectional connection 228 to a Network 220. The Network 220, in turn, is connected to a Source System 202. The connection between the Network 220 and the Source System 202 is over another bidirectional connection 214. In an example embodiment, the Network is connected, by bidirectional connection, to more than one Source System, such as Source System one 202, Source System two 204, and up to Source System N 206. Each of the multiple Source Systems has an independent bidirectional connection with the Network 220, including 214, 216, and 218, respectively. When a synchronization process begins, a user selects a Source System from the available Source Systems.

Each of Target System 222 and the at least one Source System 202, 204, and 206, includes an at least one processing device. The processing devices are necessary to execute searches of the objects in the backend object data hierarchies. The processing devices are also necessary, on an individual basis, to meet the unique needs of the application hosted by the respective Source System or Target System. The processing device of the synchronization engine is further necessary to perform all synchronization activities described herein. The processing devices of the Source System and the Target Systems perform all operations and executions described as being performed by the respective Source System or Target System. In an example embodiment, the processing device is a processor hosted on a single board computer. The processing device can be one of a microprocessor, a multi-core processor, or a central processing unit. In an example embodiment, the processing device hosts an operating system that executes software to perform all described processing tasks needed in the synchronization engine specifically or the Target System and the Source System generally.

In an example embodiment, when the user selects a Source System from the user interface on the Target System, the Target System generates a query for all search relevant attribute values. The query is sent over the bidirectional connection 228 to the Network 220, and the Network 220 forwards the query to the appropriate Source System, such as Source System one 202, over the appropriate bidirectional connection 214. The Source System one 202 returns, over the bidirectional connection 214, the query results including the search relevant attribute values to the Network 220 to be forwarded, over bidirectional connection 228, to the Target System 222. The Synchronization Engine of the Target System 222 accepts the query results and uses the hierarchical data model on the Source System to read all relevant objects that satisfy the search relevant attribute values from the query results.

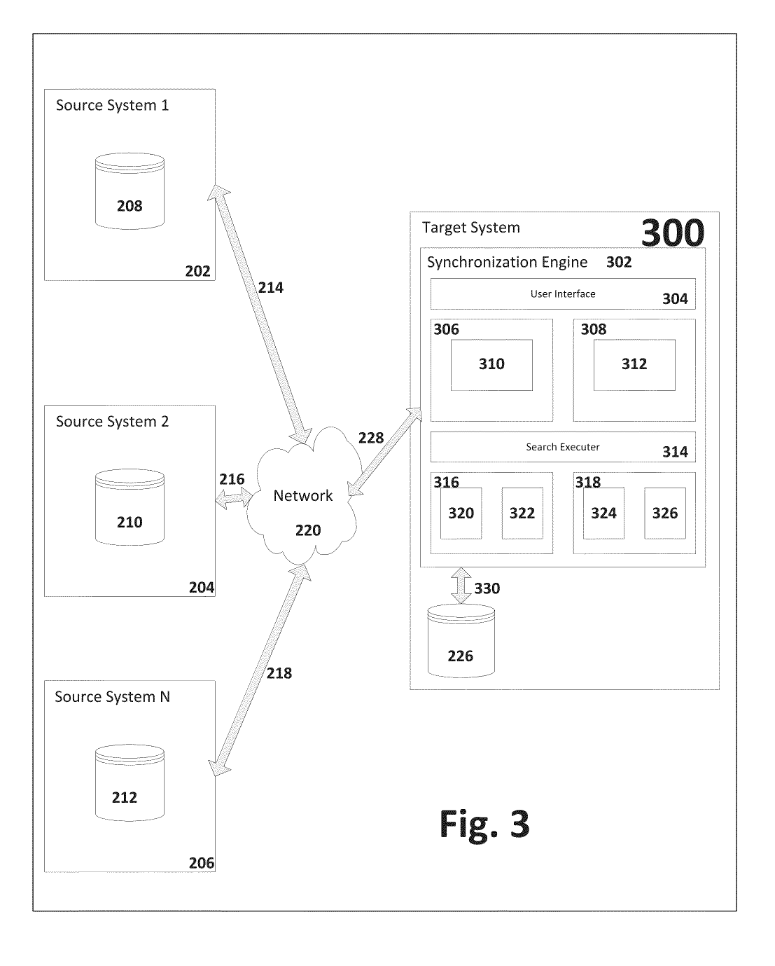

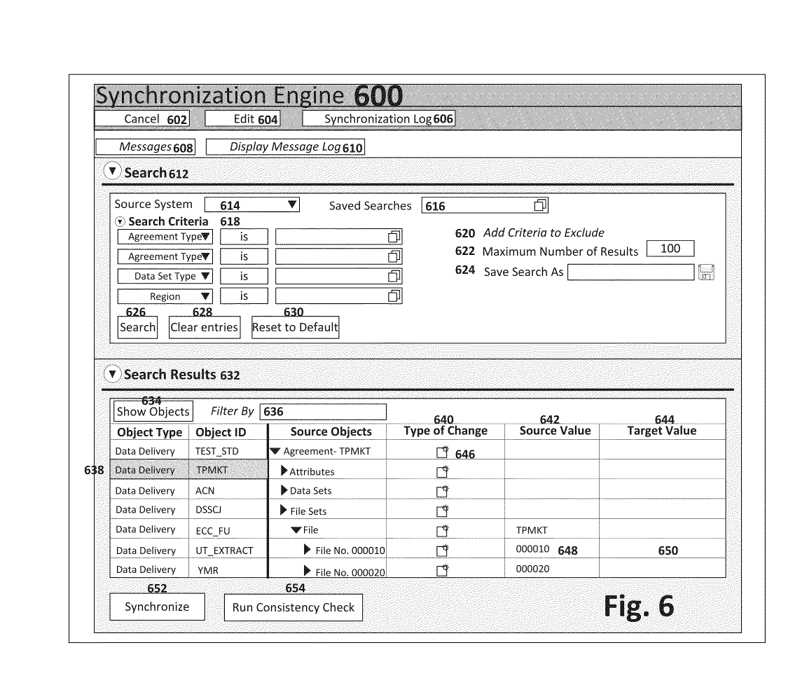

FIG. 3 illustrates a Target System 300 having a Synchronization Engine 302 for synchronizing at least one Source System with a Target System according to an example embodiment. As described with reference to FIG. 2, user generated queries are forwarded to a selected Source System, and query results are returned to the Target System from the selected Source System over the Network 220 and bidirectional connection 214 and bidirectional connection 228. FIG. 3 illustrates an example embodiment of the Target System 300 where the queries are generated and the query results are received. The Target System 300 hosts the Synchronization Engine 302. In an example embodiment, the Synchronization Engine 302 has a user interface 304. In an example embodiment, the Synchronization Engine 302 has a hierarchical objects comparator 316. The hierarchical objects comparator can include generic comparator 320 and up to a comparator N 322. The comparator 316 compares the identified search relevant objects returned from the query with the hierarchical dependent objects from the target system 300. In an example embodiment, the Synchronization Engine 302 has a configuration consistency checker 318. In an example embodiment, the Synchronization Engine has a search executer 314. The search executer 314 parses, processes, and sends a user search to the applicable search system. In an example embodiment, the Synchronization Engine has a user interface model builder 308. The user interface model builder 308 allows the user to configure the user interface 304 to: connect to the Source System 202 when called from the target-system 300; search relevant objects that are to be synchronized between the Target System 300 and the Source System 202; provide search results that show the results from the comparison of the relevant source objects and target objects; perform a detailed comparison between the objects in a full data model hierarchy; and review a delta-only view that displays only the distinctions between the target objects and the source objects. In an example embodiment, the Synchronization Engine 302 has a hierarchy object model builder 306. In an example embodiment, the hierarchy object model builder 306 has a backend hierarchical object model definition 310. Backend hierarchical object model definitions 310 is used by the Synchronization Engine to search according to a target system query that references key nodes of identified objects from a user search query. In an example embodiment, the Synchronization Engine 302 interacts with an application configuration 226 available on the Target System 300. The application configuration 226 is to be updated, according to a synchronization request from a user based on an applicable source system. The Synchronization Engine 302 interacts with the application configuration on the Target System 300 by performing one of a read operation and a write operation over a bidirectional connection 330. The configuration consistency checker performs a consistency check, prior to synchronization, consistent with a consistency check identified with reference to FIG. 6. The configuration consistency checker 318 includes at least an Attribute Checker 324 and a Configuration Simulation Checker 326.

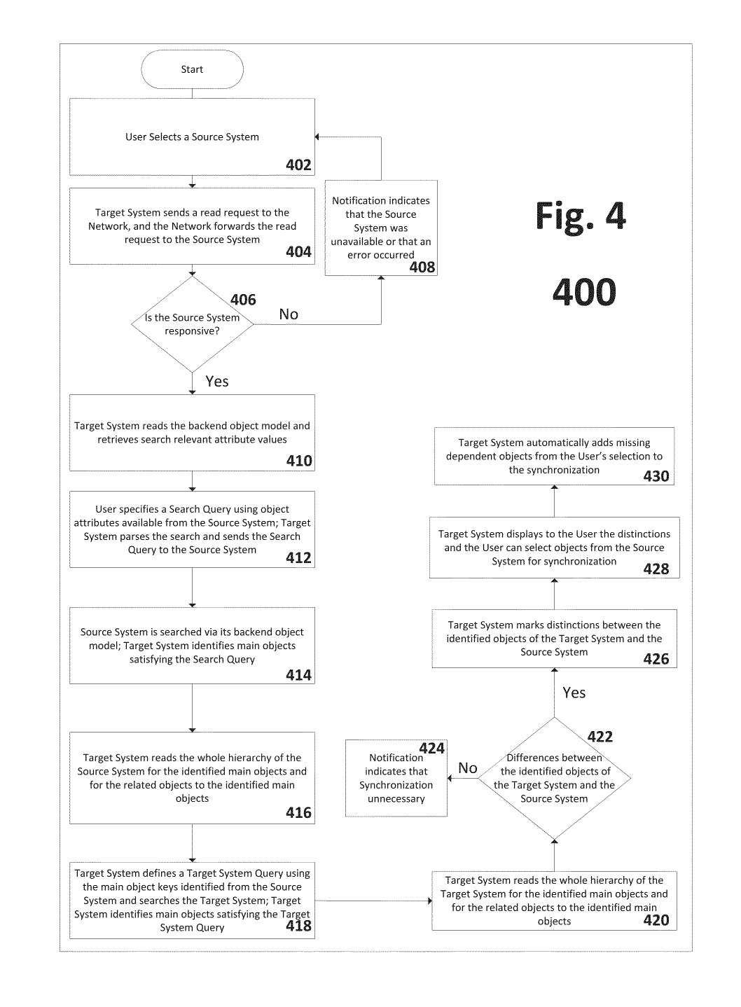

FIG. 4 is a flowchart of a method 400 for synchronizing a Target System and at least one Source System using a Synchronization Engine according to an example embodiment. During the synchronization process, the objects stored on at least one Source System are synchronized by the Synchronization Engine such that the relevant Source System objects are also available on the Target System. According to an example embodiment, the method synchronizes the user selected main objects from the user-selected Source System into the Target System. In an example embodiment, the method synchronizes the user selected main objects from the user-selected Source System into the Target System, as well as all objects related to the user selected main objects.

In a first step 402, the user selects a Source System for synchronization. According to an example embodiment, a Source System is selected from a plurality of available Source Systems. The selected Source System is used to synchronize the Target System. By synchronization, it is meant that the main objects of the Source System are included as main objects of the Target System. In an example embodiment, more than one Source System may be selected for synchronization where the synchronization process of multiple Source Systems is performed in a sequential manner. In that particular embodiment, for example with reference to FIG. 2, Source System one 202 would first be synchronized with the Target System, and after completion of the synchronization between Source System one 202 and the Target System 222, only then would Source System two 204 be synchronized with the Target System 222. To handle multiple pending synchronizations, the Target System can develop a Source System sequence according to one of the following example embodiments. In an example embodiment, the Target System synchronizes with the Source Systems in the order that searches designating the Source Systems were executed. In an example embodiment, the Target System synchronizes with the Source Systems in accordance with a predetermined Source System hierarchy. In an example embodiment, the Target System synchronizes with the Source Systems in a randomized order. In an example embodiment, the Target System synchronizes with the Source Systems according to an interrupt schema.

In a second step 404, the Synchronization Engine of the Target System sends a read request corresponding to the selected Source System to the Network. The Network forwards the read request to the corresponding Source System. In an example embodiment, referring to FIG. 2, the Target System 222 sends a read request, including information about the desired Source System 202 for synchronization, over bidirectional connection 228 to the Network 220. The Network 220 handles the read request, recognizes that the corresponding Source System is Source System 202 and forwards the read request, over bidirectional connection 214 to Source System one.

In a third step 406, the Network determines whether or not the corresponding Source System is responsive to the read request. In an example embodiment, referring to FIG. 2, the Network 220 determines whether or not Source System one 202 will comply with the read request. In an example embodiment, the Network 220 does not receive information responsive to the read request from the corresponding source system and the method proceeds according to step 408. In an example embodiment, the Network 220 does receive information responsive to the read request from the corresponding source system and the method proceeds according to step 410. In an example embodiment, responsive to the read request, the Source System one 202 provides responsive data to the Network 220. In an example embodiment, responsive to the read request, the Source System 202 allows Synchronization Engine of the Target System 222 access over Network 220 and provides the responsive data directly for access on the Source System one 202.

In a step 408, a Notification indicates that the Source System was unavailable or that an error occurred in the read request. In an example embodiment, a Notification is provided to the user over a user interface 304 of the Target System 222 in the event that a predetermined time from the beginning of the search expires. In an example embodiment, the Network 220 provides an intermediary notification to the Synchronization Engine the Target System 222 related to the failed or erroneous read request and Target System 222 generates a new Notification to the user via the user interface 304. In an example embodiment, the Network modifies an intermediary notification received from the Network 220 and presents the modified notification to the user via user interface 304.

In a fourth step 410, the Synchronization Engine of the Target System reads the backend object model of the Source System and retrieves search relevant attribute values. In an example embodiment, referring to FIG. 2, the selection of the Source System in the Synchronization Engine 224 of Target System 222 is sent over bidirectional connection 228 to the Network 220, and the Network 220 forwards the search query to the Source System one 202. The Source System one 202 has a backend object model, resembling the object model presented in FIG. 1, and the Synchronization Engine retrieves the search relevant attribute values from the Source System one 202. In an example embodiment, search relevant attribute AGR_ATTR 116 is retrieved. In an example embodiment, the entire family of objects related to search relevant attribute AGR_ATTR 116 is retrieved. In an example embodiment, only dependent objects from search relevant attribute AGR_ATTR 116, such as DESCR 120, ORIGIN 122, and PROC_DEF 124, are retrieved.

In a fifth step 412, the User specifies a search query using the retrieved objects from the applicable Source System. The Synchronization Engine of the Target System parses the search query and sends the search query to the corresponding Source System. The User specifies a search query by creating the search query or by modifying an existing search query on the Target System. In an example embodiment, referring to FIG. 3, the user interacts with the user interface 304 of the Synchronization Engine 302 to create the search. An example embodiment of a user interface is further described with reference to FIG. 6. The User specified search query is designed to, by selecting object attributes from the Source System, result in the Synchronization Engine retrieving all objects having the selected object attributes from the search relevant attribute values retrieved in the fourth step 410. In an example embodiment, the retrieved search relevant attribute values are used to populate at least one search field on the Target System. The User, by viewing the available retrieved search relevant attribute values, can accordingly select at least one of the retrieved search relevant attribute values to construct the search query. In an example embodiment, once the User requests that the Target System executes the search query, the search executor 314 parses the search query. In an example embodiment, the User requests that the search executor 314 of the Target System executes the search query by interacting with the user interface 304. In an example embodiment, the parsed search query is sent to the corresponding Source System. The Synchronization Engine of the Target System 300 sends the search query over bidirectional connection 228 to the Network 220. The Network 220 forwards the search query to the corresponding Source System, Source System one 202, over bidirectional connection 214.

In a sixth step, 414, the Synchronization Engine reads the Source System through its backend object model. By reading the backend object model, the Synchronization Engine of the Target System identifies main objects satisfying the Search Query. The backend data model of the Source System specifies all available main objects and objects that depend from the available main objects. The backend data model further specifies the hierarchical relationship between the available main objects and objects that depend from the available main objects. According to an example embodiment, each main object has its own hierarchy. According to an example embodiment, an object that is a main object in one hierarchy can be a dependent object in a different hierarchy. In an example embodiment, referring to FIG. 1, the backend data model of the Source System resembles the backend data model presented in FIG. 1. In an example embodiment, referring to FIG. 3, the Synchronization Engine of the Target System 300 reads, over bidirectional connection 228, Network 220, and bidirectional connection 214, the backend object model of Source System one 202. In an example embodiment, the Synchronization Engine of the Target System 300 identifies AGREEMENT 110, from hierarchical representation of main object AGREEMENT 100B within Source System one 202, as a main object that satisfies the Search Query.

In a seventh step, 416, the Synchronization Engine of the Target System reads the whole hierarchy of the applicable Source System for the identified main objects and for the related objects to the identified main objects. In an example embodiment, referring to FIGS. 1 and 3, the Synchronization Engine of the Target System reads the whole hierarchy of the identified main object. For example, the Synchronization Engine of the Target System 300 will read the whole hierarchy of the identified main object, AGREEMENT 110, from Source System 1 202 and thereby read all of the dependent objects: FILESET 114, AGR_ATTR 116, FILE 118, DESCR 120, ORIGIN 122, PROC_DEF 124, FILE_NO 130, and CODEPAGE 132.

In an eighth step, 418, the Synchronization Engine of the Target System defines a Target System Query using the main object keys identified from the applicable Source System, and then searches the Target System. The Synchronization Engine of the Target System identifies main objects within the Target System satisfying the Target System Query. The Target System Query is a search query of the main objects on the Target System that is based on the key nodes from the identified main objects of the Source System. According to an example embodiment, referring to FIG. 3, the Search Executer 314 searches the Target System 300 for criteria satisfying the Target System Query. In an example embodiment, the Search Executer specifically searches the Hierarchy Object Model Builder 306 and its Backend Hierarchical object Model Definition 310.

In a ninth step, 420, the Synchronization Engine of the Target System reads the whole hierarchy of the Target System for the identified main objects and for the related objects to the identified main objects. As suggested above, referring specifically to FIG. 3, in an example embodiment the Synchronization Engine of the Target System 300 proceeds to read the entire hierarchy of the Target System for the identified main objects by using the entire Hierarchy Model Builder 306 with respect to those particular identified main objects within its Backend Hierarchical object Model Definition 310.

In a tenth step, 422, the Synchronization Engine of the Target System determines whether there are differences between the identified objects of the Target System and the identified objects of the Source System. In doing so, in an example embodiment, the Synchronization Engine of the Target System considers the relative objects of the identified objects in the Target System and the relative objects of the identified objects of the Source System. In an example embodiment, no differences are noted by the Synchronization Engine between the identified objects of the Target System and the identified objects of the Source System and the method proceeds according to step 424. In an example embodiment, differences are noted by the Synchronization Engine between the identified objects of the Target System and the identified objects of the Source System and the method proceeds according to step 426. In an example embodiment, referring to FIG. 3, the differences determination is performed by the hierarchical objects comparator 316 within the Synchronization Engine. In an example embodiment, the differences between the identified objects of the Source System and the identified objects in the Target System are determined by a generic comparator 320. In an example embodiment, the differences between the identified objects of the Source System and the identified objects in the Target System are determined by a plurality of comparators, including those known in the art, including and up to and including comparator N 322.

In step 424, the Synchronization Engine provides a Notification that indicates that synchronization is unnecessary between the Target System and the Source System according to the User generated Search Query. In an example embodiment, a Notification is provided to the user via the user interface 304. The Notification can be any method of communication typically provided to users via a user interface. The Notification, in an example embodiment, is a message to the user that Synchronization of the two systems is unnecessary. In an example embodiment, a lack of search results in the User Interface 304 indicates that all objects, satisfying the search criteria, in the Target System and Source System are equal.

In an eleventh step, 426, the Synchronization Engine of the Target System marks distinctions between the identified objects of the Target System and the identified objects of the Source System. In an example embodiment, distinctions between the source objects and the target objects are determined. In a case where the target object and the source object are determined to be equal, the Synchronization Engine has compared the attribute values of the target object and the source object and found that they were the exact same. In a case where the target object and the source object are determined to be different, the Synchronization Engine has compared the attribute values of the target object and the source object and found that there were attribute values available for both objects but that at least one attribute value was different. In a case where the source object is determined to be new, the Synchronization Engine has determined that no equivalent object to that presented in the Source System exists in the Target System. In a case where the source object is determined to be missing, the Synchronization Engine has determined that the object does not exist in the Source System. In an example embodiment, the Synchronization Engine compares the source object to the target object according to a business rule. In an example embodiment, the business rule can be a predetermined mapping rule. In an example embodiment, the business rule can be the connection to logical system. The business rule can result in the comparison determining that a source object and a target object are equal if they have the same impact on the business process. In an example embodiment, if a difference is found in an object that is dependent from another object (the parent object), both of the parent object and the dependent object are marked by the Synchronization Engine as having a delta. In other words, the delta indicator is propagated up the hierarchical tree, since the delta in the dependent object affects all parent objects of that particular dependent object.

In an example embodiment, the Synchronization Engine of the Target System performs a deep comparison between the identified main objects of the Source System and the identified main objects of the Target System. A deep comparison includes further implementing comparison techniques between all family objects of the identified main objects, and identifying the deltas between these family objects.

In a twelfth step, 428, the Synchronization Engine of the Target System displays to the User the distinctions and the User selects objects displayed from the Source System, based on the distinctions, for synchronization. According to an example embodiment, the User has a display indicating whether, for all objects returned from the searches, the objects are New, Equal, Different, or Missing, as described herein. In an example embodiment, other descriptive terms, markings, or visualizations, other than those presented herein but known to those of skill in the art, may be used to consistently distinguish between an object (or missing object) in a Source System and a corresponding object (or missing object) in a Target System. In an example embodiment the display presented to the user by the Synchronization Engine allows for the user to expand or contract the deltas of an object retrieved by the search and selected by the user as an object of interest. The user, by expanding and contracting the relative hierarchies for the object of interest, can see a detailed view of the deltas for each object related to the object of interest. In an example embodiment, a detailed view of the deltas for each object can include deltas of attribute nodes, folder nodes, and key nodes. In an example embodiment, the user selects the objects for Synchronization by highlighting the objects of interest and clicking a “RUN” or a “SYNCHRONIZE” button 652, as shown in FIG. 6. In an example embodiment, the user selects the objects attributes for Synchronization from a drop down list. Other embodiments for selection of a series of objects known to one of skill in the art are considered incorporated herein.

In a thirteenth step, 430, the Target System automatically adds missing objects that are relatives, such as parents and/or dependents, to the identified object from the user's selection to be included in the synchronization. In an example embodiment, the Target System only adds missing dependent objects, meaning objects that depend from the user's selected objects, to be synchronized. In an example embodiment, the functionality in which the Target System automatically adds missing relative objects from the user's selected objects to be synchronized. In an example embodiment, the extent of family members selected can be enabled or disabled by the user. In an example embodiment, the Target System provides confirmation to the user that the synchronization process is completed successfully or unsuccessfully.

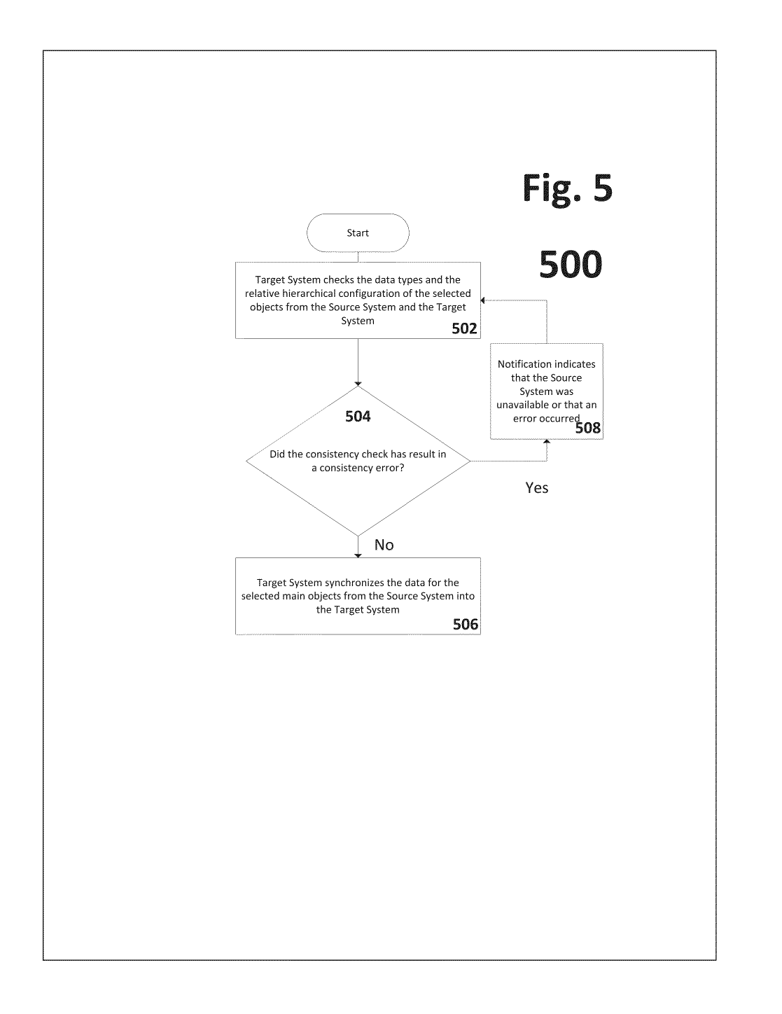

FIG. 5 is a flowchart of a method 500 for performing consistency checks during a synchronization of a Target System and one Source System using a Synchronization Engine according to an example embodiment. In a first step, 502, the Synchronization Engine of the Target System checks the data types and the relative hierarchical configuration of the selected objects from the Source System and the Target System. In a second step 504, the Synchronization Engine of the Target System determines whether the consistency check has resulted in a consistency error or no consistency error. In a third step, 506, if the Synchronization Engine of the Target System determines that there were no consistency errors, then the Target System synchronizes the data for the selected main objects from the Source System into the Target System. In an example embodiment, the Synchronization Engine of the Target System synchronizes the selected main objects and the dependent objects of the selected main objects from the Source System into the Target System. If the Synchronization Engine of the Target System determines that there were consistency errors, then the Synchronization Engine of the Target System proceeds according to step 508 and does not perform a full configuration as requested by the user. In an example embodiment, the Synchronization Engine of the Target System instead performs synchronization for only the objects for which there were no consistency errors. In an example embodiment when there are consistency errors, the Synchronization Engine of the Target System performs synchronization for none of the objects and returns an output to the user or the system administrator.

In an example embodiment, the method 500 is performed in conjunction with method 400. In an example embodiment, the method 500 is performed immediately prior to the synchronization. According to an example embodiment, the method 500 is triggered by the user's selection of objects to synchronize. In an example embodiment, the method 500 is triggered by a user selection of a general consistency check or a particular type of consistency check. According to an example embodiment, consistency checks are one of a default type, already available on Target System 300, or an additional developer created type, generated by the User and stored to be executed upon the Target System 300. According to an example embodiment, a user can delete or alter any additional developer created type consistency checks available on the Target System. According to an example embodiment, an Administrator can revoke or withhold privileges allowing a user of the Target System to delete or alter any additional developer created type consistency checks available on the Target System.

The consistency check can be one or more of the following types of checks. According to an example embodiment, the consistency check is a technical check. A technical check reads each selected object and the objects that depend from each selected object to determine whether there are any hard dependencies, as described herein. If hard dependencies are identified, the consistency check fails and notifies the user of the hard dependency. According to an example embodiment, the consistency check is a cross object check, or a business check. A cross-object check reads each selected object and the objects that depend from each selected object to perform a simulated configuration of the objects on the Target System, considering also unchanged data available on the Target System. If a simulated configuration of the objects fails, the consistency check fails and notifies the user of the failure. According to an example embodiment, the consistency check is a referential integrity check. A referential integrity check reads each selected object and the objects that depend from each selected object to determine whether attributes of the objects refer to or reference instances of other objects that have not been selected for synchronization. If objects are referred to which are not selected for synchronization and which are not part of the backend data model, the consistency checks fails and/ notifies to the user the non-synchronized objects at issue. According to an example embodiment, the consistency check is a system check. A system check is specific to attributes and includes equivalency checks for attribute nodes such that comparisons do not disregard attributes that are equivalent but that do not provide the exact same values. According to an example embodiment, the consistency check is a simulation check. A simulation check reads each selected object and the objects that depend from each selected object to determine, based on business rules and by cross-checking the future configuration, whether the resulting Target System would be sound and without errors. According to an example embodiment, the consistency check is a standard check. Standard checks allow for users to write and generate their own consistency checks. If a standard check fails, the user is notified of the failure and the reason for the failure. According to an example embodiment, the consistency check is an administrator check. An Administrator check can include variations of consistency checks needed to be performed on a regular basis particularly with respect to the types of configurations being performed. An administrator check typically involves performing initial configurations of the application configurations.

According to an example embodiment, an error message is displayed should the consistency check be unsuccessful, and no synchronization is performed until the inconsistency resulting from the consistency check is resolved. According to an example embodiment, if the consistency check is successful, the application configuration of the Target System is synchronized. According to an example embodiment, a consistency check report is generated after a consistency check is run.

FIG. 6 illustrates a user interface 600 available to a user on a Target System hosting a Synchronization Engine for synchronizing the Target System and at least one Source System according to an example embodiment.

In an example embodiment, the user interface 600 has a synchronization log 606. The user can access, by selecting the synchronization log 606, a history of previously performed synchronizations and any error messages encountered on a case by case basis. In an example embodiment, the user interface has an option to cancel an ongoing synchronization process by selecting the cancel button 602. In an example embodiment, the user interface has an option to start a synchronization process by selecting the edit button 604. Upon selection of the edit button 604, the current status of the objects are locked and the User can select objects for synchronization. In an example embodiment, the User has selected objects for synchronization by selecting checkboxes associated with the respective objects. The user interface 600 of the Synchronization Engine further includes a messages button 608, which when selected presents the user with a listing of messages received in the current session. The user interface 600 of the Synchronization Engine further includes a display messages log button 610, which when selected presents the user with a listing of messages received in previous session and information about the associated synchronizations.

In an example embodiment, the user interface has a search section 612. In the search section 612 of the user interface 600 there is at least one field for user input. User input can be provided by a variety of means of user input, including: selection of an input from a drop down list; selection of a radio button; and entering search text. Other well-known means of user input, by one of ordinary skill in the art, may also be utilized as input in the search section of the user interface. In an example embodiment, the search section 612 has a field for selection of a Source System 614. In an example embodiment, the search section has a field for previously saved searches 616. In an example embodiment, the search section has a further field for search criteria 618. Examples of search criteria include: Agreement ID, Agreement Type, Data Set Type, and Region. Search criteria are entered and edited by a user to find the available relevant objects in the Source System and the Target System. In an example embodiment, the searchable criteria are attributes of the desired main object. In an example embodiment, the search criteria are set to exclude a particular attribute. For example, the user interface of Synchronization Engine 600 includes a hyperlink to an add criteria to exclude 620. By selecting the hyperlink, a user can add additional fields to the search criteria which will exclude specific attributes of an object from returning in the search results. In an example embodiment, a search button 626 is available to execute the search based on the criteria in the search criteria 618. A reset to default button 630 is available to reset the searchable criteria 618 to a default value. A clear entries button 628 is available to clear all available entries. In an example embodiment, a field 622 is available for setting the maximum number of results that should be returned based on the search criteria. In an example embodiment, a Save Search As field 624 is available for users to save a set of search criteria among the Saved Searches 616.

In an example embodiment, the user interface 600 has a search results section 632. In the search results section 632 of the user interface 600 there is a list of objects that were returned from the search upon execution of the search. In an example embodiment, the list of objects can be updated by selection of the search button 626 in the search section 612. In an example embodiment, the list of objects can be updated by selection of the show objects button 634. In an example embodiment, when the show objects button 634 is selected the changed objects are presented in visual or textual format. In an example embodiment, when the show objects button 634 is selected all of the objects on either one of the Source System or the Target System are presented in visual or textual format. In an example embodiment, when the show objects button 634 is selected all of the objects on both of the Source System and the Target System are presented in visual or textual format. The objects are identified by their object names (object ID) and their object type. In an example embodiment, the objects are further identified by an icon 646, the icon 646 representing the type of change 640 representative of a comparison between the source object indicated by the search and the target object indicated by the search. The icon 646 is a different icon for a new object from the source object, a changed object from the source object, and so forth. In an example embodiment, upon a user selection of a source object in the search results list shown by example with the highlighted selection 638, the search results section further displays a visual representation of the object and its hierarchy with respect to family objects, including dependent objects. In an example embodiment, the visual representation of the object is a hierarchical tree of the object and its family objects. In an example embodiment, the hierarchical tree of the object displays, for each object and dependent object a type of change 640, a source value 642, and a target value 644. In an example embodiment, the hierarchical tree of the object displays three types of nodes including: attribute nodes, key nodes, and folder nodes. After the user has selected the object or objects to be synchronized, the user selects the synchronize button 652. In an example embodiment, after the user has selected the object or objects to be synchronized the user can select the run consistency check button 654 prior to synchronization.

It should be appreciated that the present invention can be implemented in numerous ways, including as a process, an apparatus, a system, a computer processor executing software instructions, or a computer readable medium such as a non-transitory computer readable storage medium, or a computer Network wherein program instructions are sent over optical or electronic communication or non-transitory links. It should be noted that the order of the steps of disclosed processes can be altered within the scope of the invention, as noted in the appended claims and in the description herein.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A system for synchronizing objects on a target system with objects on a source system, the system comprising:
the source system having a first application configuration and comprising a source hierarchical object model;
a network providing a bidirectional connection between the source system and the target system; and
the target system having a second application configuration and comprising:
a target hierarchical object model, and
a synchronization engine having a processing device,
wherein the processing device of the synchronization engine:
reads the source hierarchical object model for a set of attribute values,
receives a search query from a user of the target system,
searches the read set of attribute values from the source hierarchical object model,
identifies, from the source hierarchical object model, source objects satisfying the search query,
identifies, from the target hierarchical object model, target objects corresponding to the identified source objects,
determines a distinction between the identified source objects and the identified target objects,
synchronizes the identified target objects with a selected set of the identified source objects for which there are distinctions.

2. The system as recited in claim 1, wherein the processing device of the synchronization engine further:
identifies, from the target hierarchical object model, objects that are dependent upon the identified target objects
determines a distinction between objects that are dependent upon the identified source objects and the objects that are dependent upon the identified target objects, and
synchronizes the identified target objects and the objects that are dependent upon the identified target objects with a selected set of the identified source objects including those objects that are dependent upon the identified source objects.

3. The system as recited in claim 1, wherein the processing device of the synchronization engine determines, based on the distinction between the identified source objects and the identified target objects, a classification for each identified source object as one of: equal, new, different, or missing.

4. A device for synchronizing objects on a target system with objects on a source system, the device comprising:
a synchronization engine including:
a user interface,
a search executor,
a target hierarchical object model, and
a hierarchical objects comparator;
wherein the synchronization engine synchronizes the target system with objects on the source system by:
receiving a signal indicating a source system to be synchronized;
querying the source system for a set of object attributes;
receiving a report having at least:
objects from the source system having the set of object attributes,
objects from the target system having the set of object attributes,
determining distinctions between the objects from the source system on the report and the objects from the target system on the report; and
synchronizing, according to a user selection of a set of object from the source system on the report having distinctions, the set of objects from the source system.

5. A device as recited in claim 4, wherein the synchronization engine further synchronizes:
automatically, based on the user selection, the set of objects from the source system and objects related to the set of objects from the source system.

6. The device as recited in claim 4, wherein the synchronization engine further:
identifies, by referencing the target hierarchical object model, objects that depend from the target objects corresponding to the objects from the source system on the report,
determines a distinction between objects that depend from the objects from the source system on the report and the identified target objects, and
synchronizes the target objects and the identified target objects with a selected set of the source objects from the report including objects that depend from the source objects from the report.

7. The device as recited in claim 4, wherein the synchronization engine sequentially synchronizes the target system with objects on a plurality of source systems.

8. The device as recited in claim 4, wherein the synchronization engine further includes:
a user interface object model builder, and
a configuration consistency checker,
wherein the user interface object model builder performs a detailed comparison between a source hierarchical object model from the source system having the set of object attributes and the target hierarchical object model from the target system having the set of object attributes.

9. The device as recited in claim 4, wherein the query of the source system for the set of object attributes is defined according to at least one search criteria selected by a user.

10. The device as recited in claim 4, wherein the query of the source system for the set of object attributes is saved as a saved search.

11. The device as recited in claim 4, wherein the report includes search results that provide a source value for each object from the source system having the set of object attributes and a target value for each object from the target system having the set of object attributes.

12. A method for synchronizing objects on a target system with objects on a source system, the method comprising:
selecting a source system for synchronization;
querying the selected source system for a set of object attributes;
generating a report displaying results from the query of the source system including:
objects from the source system having the set of object attributes,
objects from the target system having the set of object attributes, and
a representation of differences between the displayed objects from the source system and the displayed objects from the target system;
selecting, based on the representation of differences, objects from the selected source system; and
synchronizing the selected objects from the selected source system.

13. The method as recited in claim 12, the method further comprising:
performing, based on the selection of objects from the source system for synchronization, a consistency check; and
after successful completion of the consistency check, synchronizing the selected objects from the selected source system.

14. The method as recited in claim 13, wherein the consistency check is defined by a user.

15. The method as recited in claim 12, the method further comprising:
determining, based on the representation of differences, a delta between a respective object from the selected source system having the set of object attributes and the corresponding respective object from the target system having the set of object attributes; and
propagating the delta from the respective object from the selected source system to all parent objects of the respective object according to a relationship structure defined in a backend source object hierarchy.

16. The method as recited in claim 12, wherein the source system and at least one additional source system are selected from a plurality of source systems and each of the selected source systems is synchronized according to a sequential order.

17. The method as recited in claim 12, wherein the representation of differences indicates one of:
a first case in which there are no differences shown in the representation of differences, and
a second case in which there are differences shown in the representation of differences,
wherein in the first case, the method further comprises providing a notification that no synchronization is necessary, and
wherein in the second case, the method further comprises displaying the representation of differences with a delta that is one of a symbol or text.

18. The method as recited in claim 13, wherein the consistency check is a referential integrity check, the referential integrity check reading each object from the selected source system having the set of object attributes and objects that depend from each object from the selected source system having the set of object attributes to determine whether attributes of the read objects refer to other objects that have not been selected for synchronization.

19. A non-transitory computer readable storage device storing program instructions that, when executed, cause a processing device to perform a method for synchronizing objects on a target system with objects on a source system, the method comprising:
receiving a signal indicating a source system to be synchronized;
querying the source system for a set of object attributes;
receiving a report having at least:
objects from the source system having the set of object attributes,
objects from the target system having the set of object attributes,
determining distinctions between the objects from the source system on the report and the objects from the target system on the report; and
synchronizing, according to a user selection of a set of objects from the source system on the report having distinctions, the set of objects from the source system.

20. The device as recited in claim 4, wherein the user interface of the synchronization engine further includes a field providing a visual representation of the distinctions between the objects.

21. The device as recited in claim 4, wherein the user interface of the synchronization engine further includes a field allowing for a user to filter through the report to find objects meeting additional criteria.
